(19) United States
(12) Patent Application Publication
(10) Pub. No.: US 2008/0128927 A1
(43) Pub. Date: Jun. 5, 2008

(54) METHODS OF MAKING HIGH GAIN OPTICAL DEVICES HAVING A CONTINUOUS AND DISPERSIVE PHASE

(75) Inventors: Ronald J. Tabar, St. Paul, MN (US); Susan L. Kent, Shorewood, MN (US); Richard C. Allen, Lilydale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/873,070

(22) Filed: Oct. 16, 2007

Related U.S. Application Data
(62) Division of application No. 10/691,981, filed on Oct. 23, 2003, now abandoned.
(60) Provisional application No. 60/420,900, filed on Oct. 24, 2002.

(51) Int. Cl. B29D 11/00

(52) U.S. Cl. 264/1.6; 264/2.7; 264/1.7

(57) ABSTRACT

Methods of making optical films having continuous phase/disperse phase morphology are disclosed which can control the nature of the disperse phase in such films to yield enhanced optical properties. When used in liquid crystal displays and the like, the films can increase the screen luminance beyond that achievable with known continuous phase/disperse phase optical films.

### CROSS REFERENCE TO RELATED APPLICATIONS

This application is a divisional of U.S. Ser. No. 10/691,981, filed Oct. 23, 2003, which claims priority to U.S. provisional application No. 60/420,900, filed Oct. 24, 2002, the disclosure of which is incorporated by reference in its entirety herein.

### FIELD OF THE INVENTION

This invention relates generally to optical films having a continuous/disperse phase morphology, and in particular to methods for controlling the nature of the disperse phase in such devices so as to improve gain and other optical properties.

### BACKGROUND

Optical and non-optical films are known in the art which are constructed from a disperse phase disposed within a continuous matrix. Such continuous/disperse phase films are described, for example, in commonly assigned U.S. Pat. No. 5,825,543 (Ouderkirk et al.), U.S. Pat. No. 5,783,120 (Ouderkirk et al.), U.S. Pat. No. 5,867,316 (Carlson et al.), U.S. Pat. No. 5,991,077 (Carlson et al.), and U.S. Pat. No. 6,179,948 (Merrill et al.), as well as in U.S. Pat. No. 6,090,898 (Tsunekawa et al.).

Continuous/disperse phase films are especially useful as diffusely reflective polarizers. In such applications, the film is typically constructed so that the refractive indices of the two phases are substantially mismatched along a first axis, and are substantially matched along a second axis. As a result, incident light polarized along the first axis is substantially reflected or scattered, while incident light polarized along the second axis is transmitted without appreciable scattering (that is, incident light polarized along the second axis is “specularly” transmitted).

The morphology of continuous/disperse phase films has been found to have a profound impact on certain optical properties. For example, U.S. Pat. No. 6,179,948 (Merrill et al.) discloses three layer films consisting of a core layer and first and second outer layers. The core layer has a monolithic composition, while each of the outer layers has a continuous/disperse phase morphology. These film structures are found to give higher transmission in the pass direction of the polarizer, and higher reflectivities in the block direction, compared to similar films in which some or all of the disperse phase is disposed in the core layer of the film. This result is said to be due to the greater fibrillation that the disperse phase experiences during extrusion as a result of being disposed in the outer layers of the film as opposed to being disposed in the core layer. U.S. Pat. No. 5,825,543 (Ouderkirk et al.) also notes greater fibrillation of the disperse phase in the exterior layers of the continuous/disperse phase films disclosed therein.

One important performance characteristic of diffusely reflective polarizers is gain. The concept of optical gain in the context of polarizers has been discussed in various references, including commonly assigned U.S. Pat. No. 5,751,388 (Larson) and U.S. Pat. No. 6,057,961 (Allen et al.). Gain is essentially a measure of the increase in screen luminance provided by a polarizer. Hence, a computer monitor equipped with a high gain polarizer will appear brighter over a certain range of viewing angles than the same monitor lacking such a polarizer. For this reason, much attention has been devoted to creating gain-enhancing polarizers. Thus, for example, U.S. Pat. No. 6,057,961 (Allen et al.) describes continuous/disperse phase polarizers which exhibit increased gain at off-angles (e.g., at 60°). However, while these polarizers represent a notable improvement in the continuous/disperse phase polarizer art, the increase in gain observed with these polarizers at off-angles typically occurs at least to some degree at the expense of the optical gain observed at normal incidence, a trade-off which is undesirable in some applications. For other display applications, increased gain at normal incidence is of primary importance, while increased gain at off-angles may not be important and may even be undesirable.

There is thus a need in the art for a continuous/disperse phase optical film which in at least some embodiments can exhibit improved optical gain, especially at normal incidence. These and other needs are provided by embodiments of the present invention, as hereinafter described.

### BRIEF DESCRIPTION OF THE DRAWINGS

FIG. 1 is a schematic diagram of a film from which composite laminated films as described herein can be derived.

FIG. 2 is a sectional view of portion of a feedblock and die apparatus incorporating a plurality of vanes to increase shear in the extrudate.

FIG. 3 is a perspective cut-away view of a portion of the apparatus of FIG. 2.

### SUMMARY

Methods are disclosed herein that permit the manufacture of relatively thin continuous/disperse phase optical films that can exhibit particularly high gain characteristics when used, for example, in display or backlight applications. The methods are believed to produce desirable morphology (greater fibrillation) of the disperse phase material throughout more of the thickness of the finished optical film than otherwise would be present by conventional known manufacturing techniques for a finished film of the same overall thickness. In one approach, a first film is extruded having at least a first surface layer and a second layer, at least the first surface layer having a continuous/disperse phase morphology. Disperse phase material within the first surface layer experiences relatively high fibrillation due to its close proximity to an outer surface of the first film, which fibrillation is at least partially maintained upon casting the first film against a casting wheel or other surface, and upon orienting the first film such as by stretching. The first surface layer is separated from the second layer and then incorporated into one or preferably multiple layers of the finished optical film. The second layer can be discarded. In some embodiments the first film can also comprise a second surface layer, where the first and second surface layers are disposed on opposed sides of the second layer. The second surface layer can then also be separated from the second layer and incorporated into the finished optical film, after casting and preferably after orienting the first film. The first and optionally the second surface layer(s) can alternately be incorporated into an intermediate laminated film which when oriented can comprise the finished film. In another approach, a plurality of vanes are employed proximate the die to promote fibrillation of the disperse phase material throughout the thickness of the cast film. A melt stream comprising the disperse phase and a continuous phase passes through the plurality of vanes and is extruded through the die. The extrudate can be cast against a casting surface and oriented to provide the finished film.

In one aspect, methods are disclosed for making continuous/disperse phase optical films or devices which exhibit improved gain characteristics. Films and devices made in accordance with the methods are also disclosed. In accordance with the method, a multilayer film or composite in which one or both of the surface layers comprise a continuous and disperse phase is produced by coextrusion or by other suitable methods. The surface layer(s) containing the continuous and disperse phase are then removed from the film and laminated together to form a new multilayer film or composite in which two or more of the layers have a continuous/disperse phase morphology.

In some embodiments, the original film or composite is made by extruding a multilayer resin stream in which a first surface layer of the resin stream has a continuous/disperse phase morphology, and casting the resin stream such that the first surface layer is disposed against a casting wheel or surface. The first surface layer is then removed from the film or composite by stripping or by other suitable methods, and is used to make the new multilayer film or composite. In order to facilitate this process, the original film or composite is designed in some embodiments such that the interface between one or both surface layers and the remainder of the film or composite is sufficiently weak so as to facilitate removal of the first surface layer. The disperse phase in the new film or composite is found to have an average particle size which is smaller than the average particle size of the original film or composite, a feature which is found to result in improved gain characteristics in the new film or composite compared to the gain characteristics of the original film or composite.

Without wishing to be bound by theory, it is believed that improvements in gain characteristics can result when the resin stream or surface layer is sufficiently thin to allow for almost complete quenching of the resin stream at the time the resin stream contacts the casting surface. This, in turn, is believed to reduce the average in-plane dimensions of the disperse phase particles, since less relaxation of stretched disperse phase particles can occur in a fully quenched web than would be the case with a web that is only partially quenched. The resulting film layer may then be used alone as a polarizer or diffuser, or may be assembled into a multilayer structure for the same or similar purposes.

In some embodiments, the resin stream may be extruded onto a release liner or similar release surface such that the release surface is disposed on the air side of the resin stream. Alternately, the resin stream may be coextruded with a release liner. If desired, a tie layer or adhesive layer may be provided between the release surface and the resin stream so that the resulting article or film fashioned from the resin stream may be removed from the release liner and readily affixed to a substrate or may be conveniently assembled into a multilayer structure.

In a further aspect, a method is disclosed herein for making a continuous/disperse phase polarizer having improved gain characteristics, whereby the average particle size and shape of the disperse phase is manipulated by controlling the distance between the disperse phase and the casting surface. In one embodiment, this is accomplished by providing a first and second resin stream, at least one of which comprises a continuous phase and a disperse phase. The first and second resin streams are then extruded into a multilayer composite which has first and second major surfaces. The multilayer composite is such that at least some of the layers in the composite comprise the material of the first resin stream and at least some of the layers in the composite comprise the material of the second resin stream, and such that the number of layers in the composite which have a continuous phase and a disperse phase and which are disposed within 75 microns of the first surface is greater than the number of layers having a continuous phase and a disperse phase and disposed within 75 microns of the second surface. The resin stream is then cast against a casting surface in such a way that the first surface is in contact with the casting surface. Multilayer films and other composites can be made in accordance with this method which exhibit improved gain characteristics compared to films in which the first surface is disposed on the air side of the resin stream, a result which may be due to the rapid quenching of the disperse phase disposed in proximity to the casting surface.

In still another aspect, a method for making a continuous/disperse phase polarizer is disclosed herein in which the amount or volume fraction of the disperse phase disposed within 75 microns of the first surface is greater than the amount or volume fraction of the disperse phase disposed within 75 microns of the second surface. Preferably in this method, essentially all of the disperse phase is disposed within 75 microns of the first surface.

In yet another aspect, a display is disclosed herein comprising a backlight and a screen, and having a polarizer disposed between the backlight and the screen. The polarizer is preferably a continuous/disperse phase polarizer. The polarizer provides a gain at normal incidence of at least about 1.46, preferably at least about 1.5, more preferably at least about 1.57, and most preferably at least about 1.58.

In still another aspect, a method for making an optical film is disclosed herein comprising the steps of providing a melt stream having a continuous phase comprising a first polymeric material and a disperse phase comprising a second polymeric material, and passing the melt stream through a plurality of vanes. The vanes can be substantially parallel and spaced apart at a distance that is sufficiently small such that the disperse phase is substantially elongated along at least one axis after the melt stream passes through the vanes. The melt stream will typically have a principle direction of flow along a first axis, and each of the plurality of vanes preferably has a longitudinal axis that is disposed essentially perpendicular to the first axis. The vanes may be disposed in a die, or may be disposed adjacent to the die lips. If the vanes are disposed adjacent to the die lips, they may be spaced apart from the die lips a desired distance. The plurality of vanes preferably define a plurality of narrow parallel channels, and the melt stream is preferably passed through these channels, after which it may be recombined into a singular melt stream.

In the various aspects noted above, the refractive indices of the continuous and disperse phases of the optical films disclosed herein will, after an orientation step, typically be sufficiently mismatched along a first in-plane axis and sufficiently matched along a second in-plane axis so that the optical film can effectively function as a polarizer. The difference in refractive indices in the mismatch direction is preferably at least 0.05, more preferably at least about 0.10, and most preferably at least about 0.15, while the difference in refractive indices in the matched direction is typically less than 0.05, more preferably less than about 0.03, and most preferably less than about 0.02 or 0.01.

### DETAILED DESCRIPTION OF THE ILLUSTRATIVE EMBODIMENTS

### A. Definitions

As used herein, the term “core layer” refers to a layer in a film to which a layer having a continuous/disperse phase structure is releasably attached. If the film has more than two layers, the core layer will typically be an interior layer in the film construction. The term “core layer” is not meant to include layers releasably attached to an exterior surface of a continuous/disperse phase layer primarily for the purpose of protecting the continuous/disperse phase layer during shipping or handling.

As used herein, the term “releasably attached” as used in reference to a layer having a continuous/disperse phase structure means that this layer can be removed as a cohesive mass from a layer that it is attached to.

As used herein, the terms “specular reflection” and “specular reflectance” refer to the reflectance of light rays into an emergent cone with a vertex angle of 16 degrees centered around the specular angle. The terms “diffuse reflection” or “diffuse reflectance” refer to the reflection of rays that are outside the specular cone defined above. The terms “total reflectance” or “total reflection” refer to the combined reflectance of all light from a surface. Thus, total reflection is the sum of specular and diffuse reflection.

Similarly, the terms “specular transmission” and “specular transmittance” are used herein in reference to the transmission of rays into an emergent cone with a vertex angle of 16 degrees centered around the specular direction. The terms “diffuse transmission” and “diffuse transmittance” are used herein in reference to the transmission of all rays that are outside the specular cone defined above. The terms “total transmission” or “total transmittance” refer to the combined transmission of all light through an optical body. Thus, total transmission is the sum of specular and diffuse transmission.

As used herein, the term “continuous/disperse phase film” refers to a film having a discontinuous phase which is dispersed in a continuous matrix.

As used herein, the term “aspect ratio” refers to the ratio of the largest average dimension of the disperse phase to the smallest average dimension of the disperse phase. Hence, films in which the disperse phase is said to have a high aspect ratio will be characterized by a disperse phase which is significantly longer as measured along one axis than as measured along another.

As used herein, the terms “gain” and “total intensity” refer to the respective measurements as described below in Section Z, “Experimental Procedures”.

### B. Overview

The present application discloses continuous/disperse phase optical films that can exhibit high optical gain in backlit displays. Such films are useful in a variety of applications, but are particularly useful, either alone or in combination with other films, as brightness enhancement films in liquid crystal displays. Preferably, the continuous and the disperse phase in the films are diverse polymeric materials, although embodiments are contemplated wherein one or both phases are non-polymeric. It is also preferred that at least the continuous phase is birefringent, although embodiments are also contemplated wherein only the disperse phase is birefringent, or wherein both phases are birefringent.

### C. Methods of Making High Gain Films

There are a number of approaches that can be utilized for achieving high gain continuous/disperse phase films in accordance with the teachings herein. Typically in these approaches, most or all of the disperse phase within the film is exposed to sufficient shear or force, preferably when it is in a softened or molten state, so as to cause the disperse phase to become stretched or elongated in at least one direction. Preferably, the particles of the disperse phase are stretched or elongated along a common axis. The disperse phase may then be maintained in this orientation through, for example, appropriate quenching and later stretching operations.

In one approach, such high gain films may be made by providing a melt stream having a continuous phase that comprises a first polymeric material and a disperse phase that comprises a second polymeric material. The melt stream is then passed through a plurality of apertures that are sufficiently narrow such that the disperse phase is substantially elongated along at least one axis after the melt stream passes through the apertures. The apertures may be defined, for example, by a plurality of flow obstructions or vanes which are spaced apart at a distance that is sufficiently small such that the disperse phase is substantially elongated along at least one axis after the melt stream passes through or past the flow obstructions or vanes. One example of an apparatus having this type of set-up and being suitable for this approach is described in U.S. Pat. No. 4,533,308 (Cloeren).

The plurality of flow obstructions or vanes may be disposed in a die, or may be disposed adjacent to a set of die lips. If the plurality of vanes are disposed in a die, they preferably define a plurality of narrowed channels, and the melt stream is preferably passed through the plurality of narrowed channels, after which it may be recombined into a singular melt stream. If the vanes are disposed adjacent to a set of die lips, they may be spaced apart from the die lips a desired distance, and the die may be fashioned, for example, as a casting die or as a drop die.

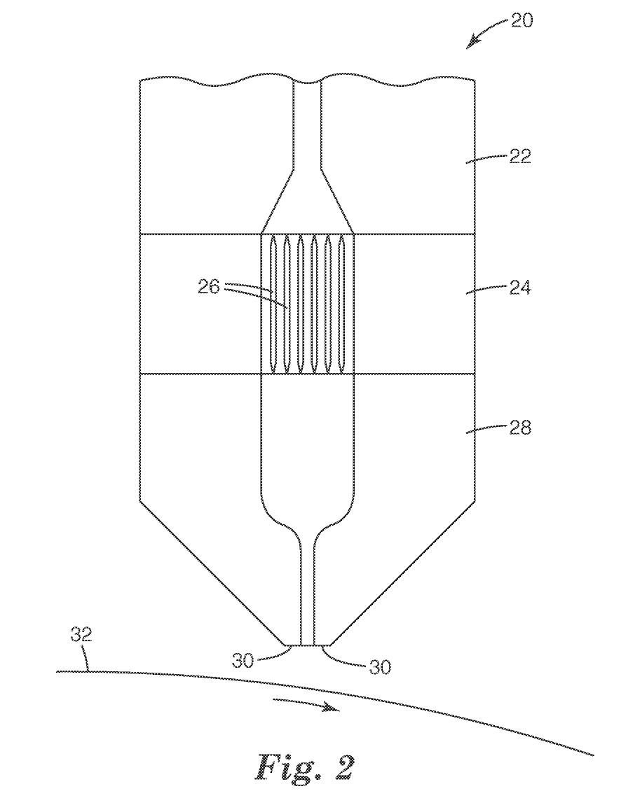

A suitable apparatus 20 is depicted schematically in FIG. 2, and a portion thereof shown schematically in perspective view in FIG. 3. In that embodiment, molten continuous/disperse phase extrudate (not shown) can be made to pass through a feedblock inlet 22 and a feedblock slot plate 24, in which is fixed a plurality of vanes 26. The vanes 26 are generally planar and parallel, each extending along one dimension parallel to the extrudate flow and along another dimension perpendicular to that flow. Vanes 26 define therebetween a plurality of apertures or slots through which the extrudate is made to flow. Slot plate 24 feeds extrudate into a conventional die 28 having die lips 30. Extrudate exiting die 28 is quenched against a casting surface 32, which may be part of a rotating casting wheel.

In another type of approach, high gain films may be made by providing a blend which comprises a polymeric continuous phase and a disperse phase, and then extruding the blend in such a way that most or all of the disperse phase is disposed sufficiently close to the surface of the extrudate so as to cause the disperse phase to undergo stretching, elongation or fibrillation as a result of the shear and elongational forces it experiences during the extrusion process (it is preferred in this approach that the extrudate be rapidly quenched after extrusion to ensure that it maintains its orientation). This result may be achieved in a number of ways.

For example, the blend may be extruded as one or both of the outer layers of a multilayer film, and these outer layers may then be removed or delaminated from the film and reassembled into a new multilayer film or construction. It is especially preferred that the new multilayer film or construction be formed from the outer layers of the original film that came into contact with the casting surface (or surfaces) during film casting. Such layers will typically be on only one side of the film, though opposing rollers or other such devices can be advantageously used as casting surfaces so that both surfaces of the original film are exposed to a casting surface. In some cases, the casting surface or surfaces may be chilled. In order to facilitate assembly of the new film or construction, the original multilayer film may be specially fabricated such that the adhesion between the outer layers and the rest of the film is poor, or can be readily made to become poor through proper treatment of the film.

In some embodiments, the blend may also be extruded as a single thin film, which may then be assembled into a multilayer construction. In this case, the film is typically sufficiently thin so that most or all of the disperse phase is disposed sufficiently close to the surface of the extrudate so as to cause the disperse phase to undergo stretching, elongation or fibrillation as a result of the shear it experiences. It is also preferred that the film is sufficiently thin to permit rapid quenching of the disperse phase after extrusion.

In some of the embodiments described herein in which a new multilayer film is constructed out of continuous/disperse phase layers taken from one or more original films, the original film may be constructed with an adhesive or bonding layer therein to facilitate assembly of the removed layer (or layers) into a new film. In such embodiments, the film may be further provided with a release liner or release surface to facilitate removal of the desired layers. The new multilayer film can also be constructed with adhesive or bonding layers to hold the constituent layers together.

Some of the approaches and methodologies described above for making high gain films in accordance with the teachings herein may be further understood with reference to the examples.

### D. Birefringence

As noted above, the continuous phase for the disclosed films is preferably, though not necessarily, birefringent. In those embodiments wherein the continuous phase is birefringent, the birefringence of the continuous phase is typically at least about 0.05, preferably at least about 0.1, more preferably at least about 0.15, and most preferably at least about 0.2.

### E. Refractive Index Differentials

In polarizing film applications, it is preferred that the indices of refraction of the continuous and disperse phases are substantially matched (i.e., differ by less than about 0.05) along a first of three mutually orthogonal axes, and are substantially mismatched (i.e., differ by more than about 0.05) along a second of three mutually orthogonal axes. Preferably, the indices of refraction of the continuous and disperse phases differ by less than about 0.03 in the match direction, more preferably, less than about 0.02, and most preferably, less than about 0.01. The indices of refraction of the continuous and disperse phases preferably differ in the mismatch direction by at least about 0.05, more preferably, by at least about 0.1, and most preferably, by at least about 0.2.

The mismatch in refractive indices along a particular axis has the effect that incident light polarized along that axis will be substantially scattered, resulting in a significant amount of reflection. By contrast, incident light polarized along an axis in which the refractive indices are matched will be spectrally transmitted or reflected with a much lesser degree of scattering. This effect can be utilized to make a variety of optical devices, including reflective polarizers and mirrors.

### F. Effect of Index Match/Mismatch

The materials of at least one of the continuous and disperse phases are preferably of a type that undergoes a change in refractive index upon orientation. Consequently, as the film is oriented in one or more directions, refractive index matches or mismatches are produced along one or more axes. Such orientation may be uniaxial or biaxial. If the orientation is biaxial, it may occur simultaneously along two or more axes, or the film may be oriented sequentially along the two or more axes. Most typically, the film will be oriented by mechanically stretching it in one or more directions. As the film is stretched in a particular direction, it may be constrained in the transverse direction, or may be unconstrained to allow dimensional relaxation. The film may also be oriented in a symmetric or asymmetric fashion.

By careful manipulation of orientation parameters and other processing conditions, the positive or negative birefringence of the matrix can be used to induce diffuse reflection or transmission of one or both polarizations of light along a given axis. The relative ratio between transmission and diffuse reflection is dependent on the concentration of the disperse phase inclusions, the thickness of the film, the square of the difference in the index of refraction between the continuous and disperse phases, the size and geometry of the disperse phase inclusions, and the wavelength or wavelength band of the incident radiation.

The magnitude of the index match or mismatch along a particular axis directly affects the degree of scattering of light polarized along that axis. In general, scattering power varies as the square of the index mismatch. Thus, the larger the index mismatch along a particular axis, the stronger the scattering of light polarized along that axis. Conversely, when the mismatch along a particular axis is small, light polarized along that axis is scattered to a lesser extent and is thereby transmitted specularly through the volume of the body.

If the index of refraction of the inclusions (i.e., the disperse phase) matches that of the continuous host media along some axis, then incident light polarized with electric fields parallel to this axis will pass through unscattered regardless of the size, shape, and density of inclusions. If the indices are not matched along some axis, then the inclusions will scatter light polarized along this axis. For scatterers of a given cross-sectional area with dimensions larger than approximately λ/30 (where λ is the wavelength of light in the media), the strength of the scattering is largely determined by the index mismatch. The exact size, shape and alignment of a mismatched inclusion play a role in determining how much light will be scattered into various directions from that inclusion. If the density and thickness of the scattering layer is sufficient, according to multiple scattering theory, incident light will be either reflected or absorbed, but not transmitted, regardless of the details of the scatterer size and shape.

When the material is to be used as a polarizer, it is preferably processed, as by stretching and allowing some dimensional relaxation in the cross stretch in-plane direction, so that the index of refraction difference between the continuous and disperse phases is large along a first axis in a plane parallel to a surface of the material and small along the other two orthogonal axes. This results in a large optical anisotropy for electromagnetic radiation of different polarizations. The techniques described herein can take advantage of the fibrillation or elongation of the disperse phase material as a result of its passage through the feedblock/die apparatus and quenching on the casting surface. Such elongation is generally in a direction parallel to the direction of motion of the web, i.e., in the so-called machine direction (MD). When stretching the cast film substantially uniaxially for the purpose of making a polarizer, such stretching can be performed either along the MD or along the transverse direction (TD) of the film. Stretching along the TD increases the width of the finished film, permitting it to be used in large area applications. In some applications, however, it may be desirable to have a substantial refractive index difference along a second in-plane axis perpendicular to the first axis so as to produce an unbalanced diffusing film (that is, a film in which orthogonal polarizations are scattered in different amounts) or a balanced diffusing film or mirror (that is, a film in which orthogonal polarizations are scattered in equal amounts).

### G. Methods of Obtaining Index Match/Mismatch

The materials selected for use in a polarizer, and the degree of orientation of these materials, are preferably chosen so that the phases in the finished polarizer have at least one axis for which the associated indices of refraction are substantially equal. The match of refractive indices associated with that axis, which typically, but not necessarily, is an axis transverse to the direction of orientation, results in substantially no scattering of light in that plane of polarization.

The disperse phase may also exhibit a decrease in the refractive index associated with the direction of orientation. If the birefringence of the host is positive, a negative strain induced birefringence of the disperse phase has the advantage of increasing the difference between indices of refraction of the adjoining phases associated with the orientation axis while the reflection of light with its plane of polarization perpendicular to the orientation direction is still negligible. Differences between the indices of refraction of adjoining phases in the direction orthogonal to the orientation direction should be less than about 0.05 after orientation, and preferably, less than about 0.02. The minimum acceptable index difference will depend on several factors, including the end-use application, the film thickness, and the size, shape, and concentration of the disperse phase.

The disperse phase may also exhibit a positive strain induced birefringence. However, this can be altered by means of heat treatment to match the refractive index of the axis perpendicular to the orientation direction of the continuous phase. The temperature of the heat treatment should not be so high as to relax the birefringence in the continuous phase.

### H. Size of Disperse Phase

The size of the disperse phase also can have a significant effect on scattering. If the disperse phase particles are extremely small (i.e., less than about 1/30 the wavelength of light in the medium of interest) and if there are many particles per cubic wavelength, the optical body behaves as a homogeneous medium with an effective index of refraction somewhat between the indices of the two phases along any given axis. In such a case, very little light is scattered. If the particles are extremely large, the light is specularly reflected from the surface of the particle, with very little diffusion into other directions. When the particles are too large in at least two orthogonal directions, undesirable iridescence effects can also occur. Practical limits may also be reached when particles become large in that the thickness of the optical body becomes greater and desirable mechanical properties can be compromised.

The ideal dimensions of the particles of the disperse phase after alignment depends on the desired use of the optical material. Thus, for example, the particle dimensions can be chosen or controlled as a function of the wavelength of electromagnetic radiation that is of interest in a particular application, with different dimensions required for reflecting or transmitting visible, ultraviolet, infrared, and microwave radiation. Generally, however, the dimension of the particles in the thickness direction of the films will be such that they are approximately greater than the wavelength of electromagnetic radiation of interest in the medium, divided by 30.

Preferably, in applications where the optical body is to be used as a low loss reflective polarizer, the particles will have a length in the machine direction that is greater than about 2 times the wavelength of the electromagnetic radiation over the wavelength range of interest, and preferably over 4 times the wavelength. The average diameter of the particles in the transverse direction is preferably equal to or less than the wavelength of the electromagnetic radiation over the wavelength range of interest, and preferably less than half of the desired wavelength. While the dimensions of the disperse phase are a secondary consideration in most applications, they become of greater importance in thin film applications, where there is comparatively little diffuse reflection.

### I. Geometry of Disperse Phase

In high gain films, the disperse phase will typically be fibrillar or elongated, thus resulting in a film with a disperse phase that has a high average aspect ratio. As shown herein, such films exhibit improved gain compared to similar films in which the disperse phase has a smaller average aspect ratio. However, within this context, the disperse phase may have a variety of shapes.

While index differentials are the predominant factor relied upon to promote scattering in the films of the present invention, the geometry of the particles of the disperse phase can also have an effect on scattering. Thus, the depolarization factors of the particles for the electric field in the index of refraction match and mismatch directions can reduce or enhance the amount of scattering in a given direction. For example, when the disperse phase is elliptical in a cross-section taken along a plane perpendicular to the axis of orientation, the elliptical cross-sectional shape of the disperse phase contributes to the asymmetric diffusion in both back scattered light and forward scattered light. The effect can either add or detract from the amount of scattering from the index mismatch, but generally has a small influence on scattering in the preferred range of properties disclosed herein.

The shape of the disperse phase particles can also influence the degree of diffusion of light scattered from the particles. This shape effect is generally small but increases as the aspect ratio of the geometrical cross-section of the particle in the plane perpendicular to the direction of incidence of the light increases and as the particles get relatively larger. In general, the disperse phase particles should be sized less than several wavelengths of light in one or two mutually orthogonal dimensions if diffuse, rather than specular, reflection is preferred.

A low loss reflective polarizer can consist essentially of a disperse phase disposed within the continuous phase as a series of rod-like structures that, as a consequence of orientation, have a high aspect ratio permitting enhancement of reflection for polarizations parallel to the orientation direction by increasing the scattering strength and dispersion for that polarization relative to polarizations perpendicular to the orientation direction. However, the disperse phase may be provided with many different geometries. Thus, the disperse phase may have cross sections which are approximately elliptical (including circular), polygonal, irregular, or a combination of one or more of these shapes. The cross-sectional shape and size of the particles of the disperse phase may also differ from one particle to another, or from one region of the film to another (e.g., from the surface to the interior).

In some embodiments, the disperse phase may have a core and shell construction, wherein the core and shell are made out of the same or different materials, or wherein the core is hollow. Thus, for example, the disperse phase may consist of hollow fibers or ellipsoids of equal or random lengths, and of uniform or non-uniform cross section. The interior space of the fibers may be empty, or may be occupied by a suitable medium which may be a solid, liquid, or gas, and may be organic or inorganic. The refractive index of the medium may be chosen in consideration of the refractive indices of the disperse phase and the continuous phase so as to achieve a desired optical effect (e.g., reflection or polarization along a given axis).

The geometry of the disperse phase may be arrived at through suitable orientation or processing of the optical material, through the use of particles having a particular geometry, or through a combination of the two. Thus, for example, a disperse phase having a substantially rod-like structure can be produced by orienting a film consisting of approximately spherical disperse phase particles along a single axis. The rod-like structures can be given an elliptical cross-section by orienting the film in a second direction perpendicular to the first. As a further example, a disperse phase having a substantially rod-like structure in which the rods are rectangular in cross-section can be produced by orienting in a single direction a film having a disperse phase consisting of a collection of essentially rectangular flakes.

Stretching is one convenient manner for arriving at a desired geometry, since stretching can also be used to induce a difference in indices of refraction within the material. As indicated above, the orientation of films disclosed herein may occur in more than one direction, and may be sequential or simultaneous.

In another example, the components of the continuous and disperse phases may be extruded such that the disperse phase is rod-like in one axis in the unstretched film. Rods with a high aspect ratio may be generated by stretching in the direction of the major axis of the rods in the extruded film.

Films having a fibrillated disperse phase can be produced by asymmetric biaxial stretching of a blend of essentially spherical particles within a continuous matrix. Alternatively, the structure may be obtained by incorporating a plurality of fibrous structures into the matrix material, aligning the structures along a single axis, and stretching the mixture in a direction transverse to that axis. Still another method for obtaining this structure is by controlling the relative viscosities, shear, or surface tension of the components of a polymer blend so as to give rise to a fibrous disperse phase when the blend is extruded into a film. In this latter case, it is preferred to apply the shear in the direction of extrusion.

### J. Dimensional Alignment of Disperse Phase

Dimensional alignment is also found to have an effect on the scattering behavior of the disperse phase. In particular, it has been observed that aligned scatterers do not scatter light symmetrically about the directions of specular transmission or reflection as randomly aligned scatterers do. Thus, inclusions that have been elongated through stretching to resemble rods scatter light primarily within angular cones centered on the orientation direction and on the specularly transmitted direction. This may result in an anisotropic distribution of scattered light (which may be transmitted or reflected light) about the specular reflection and specular transmission directions. For example, for a collimated light beam incident on such an elongated rod in a direction perpendicular to the orientation direction, the scattered light appears as a band of light in the plane perpendicular to the orientation direction with an intensity that decreases with increasing angle away from the specular directions. By tailoring the geometry of the inclusions, as through the selection of a disperse phase that has a particular geometry (e.g., spherical, cubical, etc.) in its unstretched state, some control over the distribution of scattered light can be achieved both in the transmissive hemisphere and in the reflective hemisphere.

### K. Dimensions of Disperse Phase

In applications where the optical body is to be used as a low loss reflective polarizer, the structures of the disperse phase preferably have a high aspect ratio, i.e., the structures are substantially larger along one axis than along any orthogonal axis. The aspect ratio is preferably at least 2, and more preferably at least 5. The largest dimension (i.e., the length) is preferably at least 2 times the wavelength of the electromagnetic radiation over the wavelength range of interest, and more preferably at least 4 times the desired wavelength. On the other hand, the smaller (i.e., cross-sectional) dimensions of the structures of the disperse phase are preferably less than or equal to the wavelength of interest, and more preferably less than about 0.5 times the wavelength of interest.

### L. Volume Fraction of Disperse Phase

The volume fraction (or volumetric fill factor) of the disperse phase also affects the scattering of light in the optical bodies. Within certain limits, increasing the volume fraction of the disperse phase tends to increase the amount of scattering that a light ray experiences after entering the body for both the match and mismatch directions of polarized light. This factor is important for controlling the reflection and transmission properties for a given application.

The desired volume fraction of the disperse phase will depend on many factors, including the specific choice of materials for the continuous and disperse phase and the desired optical properties of the film. However, the volume fraction of the disperse phase will typically be at least about 1% by volume relative to the continuous phase, more preferably within the range of about 10 to about 50%, and most preferably within the range of about 35 to about 45%.

### M. Film Thickness

The thickness of films and other optical bodies is also an important parameter which can be manipulated to affect reflection and transmission properties. As the thickness of the film increases (assuming a constant fill factor), diffuse reflection also increases, and transmission, both specular and diffuse, decreases. Thus, while the thickness of the film will typically be chosen to achieve a desired degree of mechanical strength in the finished product, it can also be used to directly control reflection and transmission properties. Generally, with regard to polarizers used in display and backlight applications, it is desirable to maximize the gain characteristic and simultaneously minimize the thickness of the film. Thus, when comparing two polarizing films having the same gain but different thicknesses, the thinner film is generally preferred. Likewise, for two polarizing films having the same thickness but different gains, the film with the higher gain is generally preferred.

Thickness can also be controlled to make final adjustments in reflection and transmission properties of the film. Thus, for example, the device used to extrude the film can be controlled by a downstream optical device that measures transmission and/or reflection properties of the extruded film, and that adjusts extrusion rates, casting wheel speed, and/or other parameters as needed so as to maintain the film thickness, reflection, and/or transmission values within a predetermined range.

### N. Materials for Continuous/Disperse Phases

Many different materials may be used as the continuous or disperse phases in the disclosed optical bodies, depending on the specific application to which the optical body is directed. Such materials include inorganic materials such as silica-based polymers, organic materials such as liquid crystals, and polymeric materials, including monomers, copolymers, grafted polymers, and mixtures or blends thereof. The exact choice of materials for a given application will be dictated in part by the desired match and mismatch obtainable in the refractive indices of the continuous and disperse phases along a particular axis, as well as the desired physical and optical properties in the resulting film or product. However, the materials of the continuous phase will typically be sufficiently transparent over the region of the spectrum that the film or device must operate.

A further consideration in the choice of materials is that the resulting product must contain at least two distinct phases or domains. This may be accomplished by forming the film or device from two or more materials which are immiscible with each other. Alternatively, if it is desired to make a film or device from a first and second material which are not immiscible with each other, and if the first material has a higher melting point than the second material, in some cases it may be possible to embed particles of appropriate dimensions of the first material within a molten matrix of the second material at a temperature below the melting point of the first material. The resulting mixture can then be formed into a film or other product, with or without subsequent orientation, to produce an optical device.

Suitable polymeric materials for use as the continuous or disperse phase in the present invention may be amorphous, semicrystalline, or crystalline materials, including materials made from monomers based on carboxylic acids such as isophthalic, azelaic, adipic, sebacic, dibenzoic, terephthalic, 2,7-naphthalene dicarboxylic, 2,6-naphthalene dicarboxylic, cyclohexanedicarboxylic, and bibenzoic acids (including 4,4′-bibenzoic acid), or materials made from the corresponding esters of the aforementioned acids (i.e., dimethylterephthalate). Of these, 2,6-polyethylene naphthalate (PEN) is especially preferred because of its strain induced birefringence, and because of its ability to remain permanently birefringent after stretching. PEN has a refractive index for polarized incident light of 550 nm wavelength which increases after stretching when the plane of polarization is parallel to the axis of stretch from about 1.64 to as high as about 1.9, while the refractive index decreases for light polarized perpendicular to the axis of stretch. PEN exhibits a birefringence (in this case, the difference between the index of refraction along the stretch direction and the index perpendicular to the stretch direction) of 0.25 to 0.40 in the visible spectrum. The birefringence can be increased by increasing the molecular orientation. PEN may be substantially heat stable from about 155° C. to about 230° C., depending upon the processing conditions utilized during the manufacture of the film.

Polybutylene naphthalate is also a suitable material as well as other crystalline naphthalene dicarboxylic polyesters. The crystalline naphthalene dicarboxylic polyesters exhibit a difference in refractive indices associated with different in-plane axes of at least 0.05 and preferably above 0.20.

When PEN is used as one phase in the optical material, the other phase is preferably polymethylmethacrylate (PMMA) or a syndiotactic vinyl aromatic polymer such as syndiotactic polystyrene (sPS). Other preferred polymers for use with PEN are based on terephthalic, isophthalic, sebacic, azelaic or cyclohexanedicarboxylic acid or the related alkyl esters of these materials. Naphthalene dicarboxylic acid may also be employed in minor amounts to improve adhesion between the phases. The diol component may be ethylene glycol or a related diol. Preferably, the index of refraction of the selected polymer is less than about 1.65, and more preferably, less than about 1.55, although a similar result may be obtainable by using a polymer having a higher index of refraction if a similar index difference can be achieved.

Syndiotactic-vinyl aromatic polymers useful in the disclosed optical bodies include poly(styrene), poly(alkyl styrene), poly(styrene halide), poly(alkyl styrene), poly(vinyl ester benzoate), and these hydrogenated polymers and mixtures, or copolymers containing these structural units. Examples of poly(alkyl styrenes) include: poly(methyl styrene), poly(ethyl styrene), poly(propyl styrene), poly(butyl styrene), poly(phenyl styrene), poly(vinyl naphthalene), poly(vinylstyrene), and poly(acenaphthalene) may be mentioned. As for the poly(styrene halides), examples include: poly(chlorostyrene), poly(bromostyrene), and poly(fluorostyrene). Examples of poly(alkoxy styrene) include: poly(methoxy styrene), and poly(ethoxy styrene). Among these examples, as particularly preferable styrene group polymers, are: polystyrene, poly(p-methyl styrene), poly(m-methyl styrene), poly(p-tertiary butyl styrene), poly(p-chlorostyrene), poly(m-chloro styrene), poly(p-fluoro styrene), and copolymers of styrene and p-methyl styrene may be mentioned.

Furthermore, as comonomers of syndiotactic vinyl-aromatic group copolymers, besides monomers of above explained styrene group polymer, olefin monomers such as ethylene, propylene, butene, hexene, or octene; diene monomers such as butadiene, isoprene; polar vinyl monomers such as cyclic diene monomer, methyl methacrylate, maleic acid anhydride, or acrylonitrile may be employed.

The syndiotactic-vinyl aromatic polymers may be block copolymers, random copolymers, or alternating copolymers.

The syndiotactic vinyl aromatic polymers referred to herein generally have a degree of syndiotacticity of higher than 75% or more, as determined by carbon-13 nuclear magnetic resonance. Preferably, the degree of syndiotacticity is higher than 85% racemic diad, or higher than 30%, or more preferably, higher than 50%, racemic pentad.

In addition, although there are no particular restrictions regarding the molecular weight of syndiotactic-vinyl aromatic polymers useful in the disclosed embodiments, preferably, the weight average molecular weight is greater than 10,000 and less than 1,000,000, and more preferably, greater than 50,000 and less than 800,000.

Various other resins may be employed in conjunction with syndiotactic vinyl aromatic polymers. These include, for example, vinyl aromatic group polymers with atactic structures, vinyl aromatic group polymers with isotactic structures, and other polymers that are miscible with syndiotactic vinyl aromatic polymers. For example, polyphenylene ethers show good miscibility with the previous explained vinyl aromatic group polymers. Furthermore, the composition of these miscible resin components is preferably between 70 to 1 weight %, or more preferably, 50 to 2 weight %. When composition of miscible resin component exceeds 70 weight %, degradation on the heat resistance may occur, and is usually not desirable.

It is not required that the selected polymer for a particular phase be a copolyester or copolycarbonate. Vinyl polymers and copolymers made from monomers such as vinyl naphthalenes, styrenes, ethylene, maleic anhydride, acrylates, and methacrylates may also be employed. Condensation polymers, other than polyesters and polycarbonates, can also be utilized. Suitable condensation polymers include polysulfones, polyamides, polyurethanes, polyamic acids, and polyimides. Naphthalene groups and halogens such as chlorine, bromine and iodine are useful in increasing the refractive index of the selected polymer to the desired level (1.59 to 1.69) if needed to substantially match the refractive index if PEN is the host. Acrylate groups and fluorine are particularly useful in decreasing the refractive index.

Minor amounts of comonomers may be substituted into the naphthalene dicarboxylic acid polyester so long as the large refractive index difference in the orientation direction(s) is not substantially compromised. A smaller index difference (and therefore decreased reflectivity) may be counterbalanced by advantages in any of the following: improved adhesion between the continuous and disperse phase, lowered temperature of extrusion, and better match of melt viscosities.

### O. Region of Spectrum

While frequent reference is made to the visible region of the spectrum, various embodiments can be made to operate at different wavelengths of electromagnetic radiation through appropriate scaling of the components of the optical body. Thus, as the wavelength increases, the linear size of the components of the optical body may be increased so that the dimensions of these components, measured in units of wavelength, remain approximately constant.

Of course, one major effect of changing wavelength is that, for most materials of interest, the index of refraction and the absorption coefficient change. However, the principles of index match and mismatch still apply at each wavelength of interest, and may be utilized in the selection of materials for an optical device that will operate over a specific region of the spectrum. Thus, for example, proper scaling of dimensions will allow operation in bands of the infrared and ultra-violet regions of the spectrum. In these cases, the indices of refraction refer to the values at these bands of operation, and the body thickness and size of the disperse phase scattering components should also be approximately scaled with wavelength. Even more of the electromagnetic spectrum can be used, including very high, ultrahigh, microwave and millimeter wave frequencies. Polarizing and diffusing effects will be present with proper scaling to wavelength and the indices of refraction can be obtained from the square root of the dielectric function (including real and imaginary parts). Useful products in these longer wavelength bands can be diffuse reflective polarizers and partial polarizers.

In some embodiments, the optical properties of the optical body vary across the wavelength band of interest. In these embodiments, materials may be utilized for the continuous and/or disperse phases whose indices of refraction, along one or more axes, vary significantly as a function of wavelength. The choice of continuous and disperse phase materials, and the optical properties (i.e., diffuse and disperse reflection or specular transmission) resulting from a specific choice of materials, will depend on the wavelength band of interest.

### P. Skin Layers

A layer of material which is substantially free of a disperse phase may be coextensively disposed on one or both major surfaces of the film, i.e., the extruded blend of the disperse phase and the continuous phase. The composition of such layers, also called skin layers, may be chosen, for example, to protect the integrity of the disperse phase within the extruded blend, to add mechanical or physical properties to the final film or to add optical functionality to the final film. Suitable materials of choice for use in the skin layers may include the material of the continuous phase or the material of the disperse phase. Other materials with a melt viscosity similar to the extruded blend may also be useful.

A skin layer or layers may also add physical strength to the resulting composite or reduce problems during processing, such as, for example, reducing the tendency for the film to split during the stretching process. Skin layer materials which remain amorphous may tend to make films with a higher toughness, while skin layer materials which are semicrystalline may tend to make films with a higher tensile modulus. Other functional components such as antistatic additives, UV absorbers, dyes, antioxidants, and pigments, may be added to the skin layer, but preferably do not substantially interfere with or adversely affect the desired optical properties of the resulting product.

Skin layers or coatings may also be added to impart desired barrier properties to the resulting film or device. Thus, for example, barrier films or coatings may be added as skin layers, or as a component in skin layers, to alter the transmissive properties of the film or device towards liquids, such as water or organic solvents, or gases, such as oxygen or carbon dioxide.

Skin layers or coatings may also be added to impart or improve abrasion resistance in the resulting article. Thus, for example, a skin layer comprising particles of silica embedded in a polymer matrix may be added to an optical film produced in accordance with the invention to impart abrasion resistance to the film, provided, of course, that such a layer does not unduly compromise the optical properties required for the application to which the film is directed.

Skin layers or coatings may also be added to impart or improve puncture and/or tear resistance in the resulting article. Thus, for example, in embodiments in which the outer layer of the optical film contains coPEN as the major phase, a skin layer of homogeneous coPEN may be added to or (depending on its thickness) coextruded with the optical layers to impart good tear resistance to the resulting film. Factors to be considered in selecting a material for a tear resistant layer include percent elongation to break, Young's modulus, tear strength, adhesion to interior layers, percent transmittance and absorbance in an electromagnetic bandwidth of interest, optical clarity or haze, refractive indices as a function of frequency, texture and roughness, melt thermal stability, molecular weight distribution, melt rheology and coextrudability, miscibility and rate of inter-diffusion between materials in the skin and optical layers, viscoelastic response, relaxation and crystallization behavior under draw conditions, thermal stability at use temperatures, weatherability, ability to adhere to coatings and permeability to various gases and solvents. Puncture or tear resistant skin layers may be applied during the manufacturing process or later coated onto or laminated to the optical film. Adhering these layers to the optical film during the manufacturing process, such as by a coextrusion process, provides the advantage that the optical film is protected during the manufacturing process. In some embodiments, one or more puncture or tear resistant layers may be provided within the optical film, either alone or in combination with a puncture or tear resistant skin layer.

The skin layers may be applied to one or two sides of the extruded blend at any convenient point during the manufacturing process. Preferably, the skin layers are added after the continuous/disperse phase layers are extruded, so that the disperse phase in these layers will have the opportunity to undergo fibrillation. However, skin layers can also be added at other points in the process. For example, the skin layers could be coextruded with the continuous/disperse phase layers in situations where the skin layers are sufficiently thin under the processing conditions to allow the disperse phase to undergo fibrillation. Lamination of skin layer(s) to a previously formed film of an extruded blend is also possible. Total skin layer thicknesses may range from about 2% to about 50% of the total blend/skin layer thickness.

In some applications, additional layers may be coextruded or adhered on the outside of the skin layers during manufacture of the optical films. Such additional layers may also be extruded or coated onto the optical film in a separate coating operation, or may be laminated to the optical film as a separate film, foil, or rigid or semi-rigid substrate such as polyester (PET), acrylic (PMMA), polycarbonate, metal, or glass.

A wide range of polymers are suitable for skin layers. Of the predominantly amorphous polymers, suitable examples include copolyesters based on one or more of terephthalic acid, 2,6-naphthalene dicarboxylic acid, isophthalic acid phthalic acid, or their alkyl ester counterparts, and alkylene diols, such as ethylene glycol. Examples of semicrystalline polymers suitable for use in skin layers include 2,6-polyethylene naphthalate, polyethylene terephthalate, and nylon materials. Skin layers that may be used to increase the toughness of the optical film include those based on high elongation polyesters such as Ecdel™ and PCTG 5445 (available commercially from Eastman Chemical Co., Rochester, N.Y.) and polycarbonates. Polyolefins, such as polypropylene and polyethylene, may also be used for this purpose, especially if they are made to adhere to the optical film with a compatibilizer.

### Q. Microvoiding

In some embodiments, the materials of the continuous and disperse phases may be chosen so that the interface between the two phases will be sufficiently weak to result in voiding when the film is stretched. The average dimensions of the voids may be controlled through careful manipulation of processing parameters and stretch ratios, or through selective use of compatibilizers. The voids may be back-filled in the finished product with a liquid, gas, or solid. Voiding may be used in conjunction with the aspect ratios and refractive indices of the disperse and continuous phases to produce desirable optical properties in the resulting film.

### R. More than Two Phases

The disclosed optical bodies may also comprise more than two phases. Thus, for example, an optical material can consist essentially of two different disperse phases within the continuous phase. The second disperse phase could be randomly or non-randomly dispersed throughout the continuous phase, and can be randomly aligned or aligned along a common axis.

The disclosed optical bodies may also comprise more than one continuous phase. Thus, in some embodiments, the optical body may include, in addition to a first continuous phase and a disperse phase, a second continuous phase which is co-continuous in at least one dimension with the first continuous phase. In one particular embodiment, the second continuous phase is a porous, sponge-like material which is coextensive with the first continuous phase (i.e., the first continuous phase extends through a network of channels or spaces extending through the second continuous phase, much as water extends through a network of channels in a wet sponge). In a related embodiment, the second continuous phase is in the form of a dendritic structure which is coextensive in at least one dimension with the first continuous phase.

### S. Co-Continuous Phases

In some embodiments, the blends utilized may contain co-continuous phases, rather than having a continuous/disperse phase structure. This may happen, for example, if the materials used for two phases of the film have similar viscosities and are used in similar volume fractions, although a co-continuous morphology may be produced in other ways as well. As these conditions are approached, it may become difficult to distinguish between the disperse and continuous phases, as each phase becomes continuous in space. Depending upon the materials of choice, there may also be regions or domains where the first phase appears to be dispersed within the second, and vice versa.

Films having co-continuous phases may be made by a number of different methods. Thus, for example, the polymeric first phase material may be mechanically blended with the polymeric second phase material to achieve a co-continuous system. Co-continuous phases may also be formed by first dissolving them out of supercritical fluid extractions and then allowing them to phase separate following exposure to heat and/or mechanical shear. Co-continuous phases may also be produced through the creation of interpenetrating polymer networks (IPNs), including simultaneous IPNs, sequential IPNs, gradient IPNs, latex IPNs, thermoplastic IPNs, and semi-IPNs.

Co-continuity can be achieved in multicomponent systems as well as in binary systems. For example, three or more materials may be used in combination to give desired optical properties (e.g., transmission and reflectivity) and/or improved physical properties. All components may be immiscible, or two or more components may demonstrate miscibility.

The characteristic sizes of the phase structures, ranges of volume fraction over which co-continuity may be observed, and stability of the morphology may all be influenced by additives, such as compatibilizers, graft or block copolymers, or reactive components, such as maleic anhydride or glycidyl methacrylate. For particular systems, however, phase diagrams may be constructed through routine experimentation and used to produce co-continuous systems.

The microscopic structure of co-continuous systems made in accordance with the present description can vary significantly, depending on the method of preparation, the miscibility of the phases, the presence of additives, and other factors as are known to the art. Thus, for example, one or more of the phases in the co-continuous system may be fibrillar, with the fibers either randomly oriented or oriented along a common axis. Other co-continuous systems may comprise an open-celled matrix of a first phase, with a second phase disposed in a co-continuous manner within the cells of the matrix. The phases in these systems may be co-continuous along a single axis, along two axes, or along three axes.

Optical bodies made in accordance with the present description and having co-continuous phases (particularly IPNs) will, in several instances, have properties that are advantageous over the properties of similar optical bodies that are made with only a single continuous phase, depending, of course, on the properties of the individual polymers and the method by which they are combined. Thus, for example, co-continuous systems allow for the chemical and physical combination of structurally dissimilar polymers, thereby providing a convenient route by which the properties of the optical body may be modified to meet specific needs. Furthermore, co-continuous systems will frequently be easier to process, and may impart such properties as weatherability, reduced flammability, greater impact resistance and tensile strength, improved flexibility, and superior chemical resistance. IPNs are particularly advantageous in certain applications, since they typically swell (but do not dissolve) in solvents, and exhibit suppressed creep and flow compared to analogous non-IPN systems.

One skilled in the art will appreciate that the principles of co-continuous systems as are known to the art may be applied in light of the teachings set forth herein to produce co-continuous morphologies having unique optical properties. Thus, for example, the refractive indices of known co-continuous morphologies may be manipulated as taught herein to produce new optical films in accordance with the present invention. Likewise, the principles taught herein may be applied to known optical systems to produce co-continuous morphologies.

### T. Multilayer Combinations

If desired, one or more layers of a continuous/disperse phase film made in accordance with the present teachings may be laminated together to form a multilayered film, or may be used in combination with, or as a component in, a multilayered film (e.g., to increase reflectivity). Suitable multilayered films include those of the type described in WO 95/17303 (Ouderkirk et al.). In such a construction, the individual sheets may be laminated or otherwise adhered together or may be spaced apart. If the optical thicknesses of the phases within the sheets are substantially equal (that is, if the two sheets present a substantially equal and large number of scatterers to incident light along a given axis), the composite will reflect, at somewhat greater efficiency, substantially the same band width as the individual sheets. If the optical thicknesses of phases within the sheets are not substantially equal, the composite will reflect across a broader band width than the individual sheets. A composite combining mirror sheets with polarizer sheets is useful for increasing total reflectance while still polarizing transmitted light. Alternatively, a single sheet may be asymmetrically and biaxially oriented to produce a film having selective reflective and polarizing properties.

Any of the materials previously noted may be used as any of the layers in this embodiment, or as the continuous or disperse phase within a particular layer. However, PEN and co-PEN are particularly desirable as the major components of adjacent layers, since these materials promote good laminar adhesion.

When laminating two or more layers of the continuous/disperse phase film together to form a multilayered film, optically clear adhesives are preferred, coated and laminated using standard techniques. Among the adhesive options are transfer adhesives, UV curable adhesives, or chemically cured adhesives. Adhesives can be chosen for their contributions to the physical and mechanical properties, such as stiffness, to the completed laminate. Typically, the individual film layers within a laminate are aligned such that extrusion axes are parallel and the casting wheel surfaces of the individual layers all face the same major surface of the laminate.

Also, a number of variations are possible in the arrangement of the layers. Thus, for example, the layers can be made to follow a repeating sequence through part or all of the structure. One example of this is a construction having the layer pattern . . . ABCABC . . . , wherein A, B, and C are distinct materials or distinct blends or mixtures of the same or different materials, and wherein one or more of A, B, or C contains at least one disperse phase and at least one continuous phase.

### U. Functional Layers, Coatings, and Additives

Various functional layers, coatings and additives may be added to the disclosed optical films and devices to alter or improve their physical or chemical properties, particularly along the surface of the film or device. Such layers or coatings may include, for example, slip agents, adhesives, low adhesion backside materials, conductive layers, metal or metallized layers, antistatic coatings or films, antireflective layers, anti-fog layers, barrier layers (e.g., moisture or chemical barrier layers), flame retardants, UV stabilizers, absorbers, or reflectors (including, for example, hindered amine stabilizers and benzophenone- or benzotriazole-functionalized monomers or polymers), antioxidants (e.g., sterically hindered phenols, amines, amides, phosphoric acids, phosphonic acids, phosphites, and phosphonites), slip agents, dyes (including, for example, dichroic dyes), pigments, inks, imaging layers, abrasion resistant materials, opacifying or diffusing agents, optical coatings, reinforcing agents, binders, fillers, heat stabilizers, impact modifiers, plasticizers, viscosity modifiers, and/or substrates designed to improve the mechanical integrity or strength of the film or device.

Various optical layers, materials, and devices may also be applied to, or used in conjunction with, the disclosed films for specific applications. These include, but are not limited to, magnetic or magneto-optic coatings or films; liquid crystal panels, such as those used in display panels and privacy windows; photographic emulsions; fabrics; prismatic films, such as linear Fresnel lenses; brightness enhancement films; holographic films or images; embossable films; anti-tamper films or coatings; IR transparent film for low emissivity applications; release films or release coated paper; and polarizers or mirrors. Multiple additional layers on one or both major surfaces of the optical film are contemplated, and can be any combination of aforementioned coatings or films.

The films disclosed herein may also be treated with various agents or materials to facilitate their production or processing. Thus, for example, suitable lubricants may be added to the extrusion melt to facilitate the extrusion process.

### V. Surface Treatments

The films and other optical devices disclosed herein may be subjected to various treatments which modify the surfaces of these materials, or any portion thereof, as by rendering them more conducive to subsequent treatments such as coating, dying, metallizing, or lamination. This may be accomplished through treatment with primers, such as PVDC, PMMA, epoxies, and aziridines, or through physical priming treatments such as corona, flame, plasma, flash lamp, sputter-etching, e-beam treatments, or amorphizing the surface layer to remove crystallinity, such as with a hot can.

### W. General Applications

The optical films are particularly useful as diffusely reflective polarizers in displays, where the increased gain possible with these films can be used to increase screen luminance and to provide other desirable characteristics and features. However, optical films and devices may also be made which operate as forward scattering diffusers or as diffusely reflective mirrors. In these applications, the construction of the film may be similar to that of the diffusely reflective polarizers described above, but will generally differ in such features as the concentration of disperse phase in the continuous phase, the thickness of the continuous/disperse phase layers, and/or the refractive index differentials along various axes.

### X. End Uses

The optical films and devices are suitable for use in a number of applications. These include, without limitation, their use in or in conjunction with fenestrations, light fixtures, smoke detectors, light extractors, light directing materials or articles, light guides, direction control polarizers, liquid crystal panels, and computer or laptop displays. The later use is especially desirable because of the increased screen luminance possible, due to the increased gain achievable with these films.

### Y. Peel Force

In some embodiments, optical films or composite films are made from an initial multilayer film in which one or more of the outer layers of the film have a continuous/disperse phase structure. These outer layers are then stripped and incorporated as layers in new films. Thus, for example, these outer layers may be stacked to form a new multilayer film. The number of layers in the new film, and the thicknesses of the outer layers of the original film, may be chosen to optimize desired optical properties, such as gain or intensity.

In these embodiments, it is desirable that the outer layers of the original film be easily removable as a cohesive mass. Typically, this is accomplished by constructing the original film out of suitable materials such that these outer layers will have relatively poor laminar adhesion to the adjacent layer. In the extreme case, the adjacent layer may be designed to serve as a release liner for the adjoining outer layer. However, in some embodiments, a frangible tie layer may be provided between such outer layers and the adjacent layer (not including the tie layer) of the film such that the outer layers can be easily stripped.

Laminar adhesion of a continuous/disperse phase outer layer to an adjacent layer may be quantified by considering the peel force required to remove the outer layer from the adjacent layer. In these particular embodiments, this peel force is typically less than 30 N/cm, preferably less than 20 N/cm, more preferably less than 10 N/cm, and most preferably within the range of about 0.1 N/cm to about 3 N/cm, where the peel force is measured at 180 degrees at a peel rate of 90 inches/min (229 cm/min).

### Z. Experimental Procedures

The following experimental procedures and devices are referred to in the Examples included herein.

Gain Test:

The following procedure was used to measure the gain results set forth herein. The Gain Tester was custom-made for these measurements. A horizontal platform was provided, and on top of it was placed the entire backlight assembly taken from the liquid crystal display screen of a laptop computer. This assembly included a white film reflector sheet backing, a two-sided fluorescent bulb assembly, and an acrylic diffuser sheet. This assembly was placed on the platform with the diffuser sheet facing up, directing the diffused light generally vertically. Above the backlight assembly, a polarizer assembly was suspended, the polarizer assembly being adapted to rotate about a vertical axis. Above the polarizer assembly, a Minolta Luminescence Meter LS-100 (Minolta Camera Co., Ltd., Japan) was suspended so as to receive the light from the backlight which had passed through the polarizer assembly. The entire optic assembly (backlight, polarizer, and luminescence meter) was enclosed in an ambient-light-excluding shroud. The fluorescent bulb assembly was connected to and powered by a DC electrical power source.

The Gain Meter was prepared for use by turning on the fluorescent bulb assembly, closing the shroud, waiting three minutes for equilibration, and then adjusting the rotational angle of the polarizer assembly to maximize the reading of the luminescence meter.

In order to take a Gain measurement, the film specimen to be tested was placed directly on top of the backlight assembly. The fluorescent bulb assembly was again turned on, and allowed again to equilibrate for exactly three minutes. The luminescence reading was taken, the sample was quickly removed, and another reading taken immediately without the specimen in place. The ratio of the reading with specimen to the reading without specimen is the Gain.

One complication of Gain measurement on backlit displays is that gain is angularly dependent. It is thus possible that the “Gain” as measured above might not represent an increase in total intensity, since an observed increase in gain may result from light being re-directed from off-angles toward a true vertical direction. In order to account for this possibility in the Examples, the total intensity (I_{T}) and the normalized total intensity (I_{TN}) of the samples was determined in accordance with the Total Intensity Measurement Procedure described below.

Total Intensity Measurement Procedure:

The Gain Tester was modified by the addition of a removable prism assembly in the optical path, above the backlight (and optional specimen) but below the polarizer assembly. The prism assembly was constructed in such a way as to redirect the light emanating from the backlight and/or the test specimen at 40° from the vertical so that it impinged on the inlet of the luminescence meter. By taking one set of measurements as described above without the prism assembly in place, and similar measurements with the prism in place, the intensities with and without test specimen, at true vertical (0°) and at 40° from vertical, could be obtained.

From the 0° and 40° measurements, the Total Intensity integrated over 40° was estimated using the approximation of linear change in intensity over viewing angle. This Total Intensity (I_{T}) for both the backlight alone and the specimen was estimated using EQUATION 1, where K is an arbitrary constant. For calculations of Normalized Total Intensity (I_{TN}), the value of K is unimportant, since it will cancel out when the ratio of specimen intensity to backlight intensity is taken.

I_{T}=K*(0.5*(I(0°)−I(40°))+I(40°)) (EQUATION 1)

### This equation may be rewritten in simpler form as

I_{T}=K′*(I(0°)+I(40°)) (EQUATION 2)

wherein K′ is again an arbitrary constant.

Using the linear approximation above, the estimation equation is based upon approximating the area under the curve (of intensity as a function of angle) by the area underlying a line segment extending from I (0°) to I (40°). Normalized Total Intensity (I_{TN}) was calculated using EQUATION 3:

I_{TN}=I_{T}(With Sample)/I_{T}(Without Sample) (EQUATION 3)

### To illustrate the meaning of EQUATION 3, if I_{TN}=1.35, then this means that 35% more light is reaching the detector when the sample film is in place than when the sample film is removed.

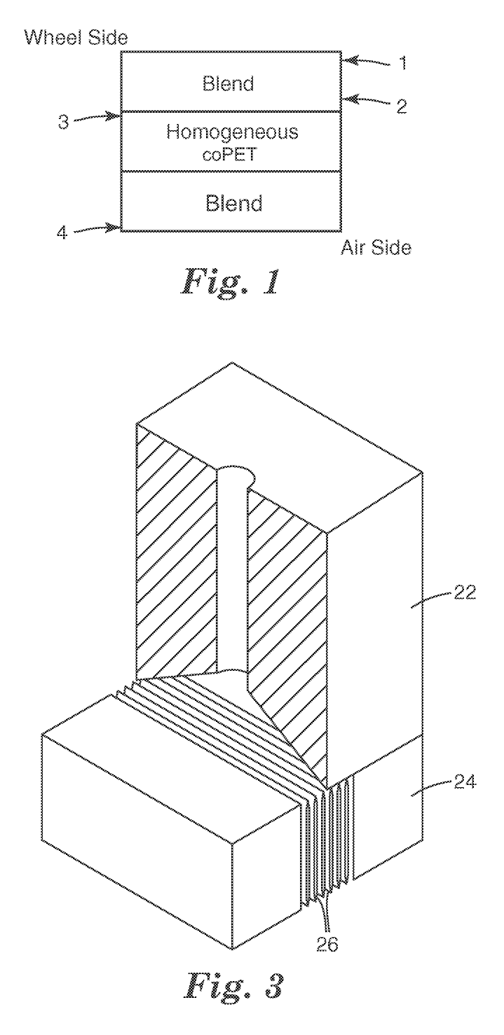

In the following examples, some of which are provided for reference or comparison purposes, the film samples are referred to in reference to the example to which they correspond. Thus, for example, E-28 refers to the film produced in Example 28. The parenthetical numbers (e.g., 1, 2, 3 and 4), when used, refer to the surfaces of the resultant films as shown in FIG. 1. The sequence of these numbers indicates the orientation of the film for the purposes of the Gain Test and the Total Intensity Measurement Procedure. Thus, for example, E-1 (1,2) refers to that surface layer of the three layer film of EXAMPLE 1 which was positioned against the casting wheel when the film was formed; the film is placed such that surface 1 (see FIG. 1) is facing the backlight, and surface 2 is facing the light meter. E-1 (2,1), on the other hand, refers to the same film in a reversed orientation (where surface 2 faces the backlight and surface 1 faces the light meter). E-1 (1,4) refers to the entire E-1 film, and is simply abbreviated as E-1. E-1 (4,3) refers to the two-layer film derived from E-1 which includes the core layer of the original film and the exterior layer of the original film which was positioned away from the casting wheel when the film was formed; the film is oriented such that surface 4 is facing the backlight and surface 3 is facing the light meter.

### Example 1

This example illustrates the production of a film from which a laminate of one of its individual layers may be derived.

A three layer film was made by coextruding a copolymer with a polymeric blend. The copolymer (co-PET) was based on 80 mole % of dimethyl terephthalate and 20 mole % dimethyl isophthalate, polymerized with ethylene glycol, and was coextruded as the central layer of the film. The polymeric blend, which was coextruded as the outer two layers of the film, consisted by weight of 52.3 percent coPEN (a copolymer based on 70 mole % naphthalene dicarboxylate and 30 mole % dimethyl terephthalate, polymerized with ethylene glycol), which provided the continuous phase, 45% sPS (Questra MA405, available from Dow Chemical Company) which provided the disperse phase, and 2.7% Dylark 332-80 compatibilizer (available from Nova Chemical Co.). The ratio of the three layers by weight was approximately 1:1:1.

The materials were coextruded onto a chilled casting wheel using a feedblock and a film drop die to form a web. The web was oriented in the machine (i.e., longitudinal) direction at a stretch ratio of approximately 1.25:1. The web was subsequently oriented in the transverse direction approximately 4.8:1 to produce a polarizing film (hereinafter referred to as E-1) approximately 175 micrometers thick. The pass axis of the film was parallel with the machine direction.

### Examples 2-7

These examples illustrate the contribution of each of the component layers of the three layer film of Example 1 to the optical performance of the overall film.

In order to assess the contribution of each of the components of a 3-layer blend polarizer film such as E-1 to the overall optical performance of the film, a sample of E-1 was delaminated into its component layers by adhering one surface of the film sample to a glass substrate and removing the other surface layer with a portion of adhesive tape.

Film E-1 (12) is approximately 60 micrometers thick and is composed of the blend layer that was adjacent to the chilled wheel during casting (“wheel side layer”). Film E-1 (34) is approximately 115 micrometers thick and is composed of the center layer and the blend layer that was opposite the chilled wheel during casting (“air side layer”). The full film can also be referred to as E-1 (14), or simply E-1.

Films E-1 (14), E-1 (12), and E-1 (34) were cut into sheets having the dimensions 229 mm×216 mm, wherein the first dimension is in the machine direction and the second dimension is in the transverse direction. The gain (also called luminance gain) of the sheets was tested in accordance with the Gain Test procedure described above. The results of the Gain Test are set forth in TABLE 1.

TABLE 1
E-1 Layers Gain

| | | | Surface | |
|---|---|---|---|---|
| | | | Toward | |
| EXAMPLE | Sample | Sample Description | Lamps | Gain¹ |
| 2 | E-1(14) | E-1, Whole Film | Wheel | 1.373 |
| 3 | E-1(41) | E-1, Whole Film | Air | 1.395 |
| 4 | E-1(12) | E-1, Wheel Side Layer | Wheel | 1.261 |
| 5 | E-1(21) | E-1, Wheel Side Layer | Core | 1.310 |
| 6 | E-1(43) | E-1, Air Side Layer + | Air | 1.237 |
| | | co-PET Core Layer | | |
| 7 | E-1(34) | E-1, Air Side Layers + | Core | 1.273 |
| | | co-PET Core Layer | | |

¹Measured on gain tester #1, day 1

Since the gain measured on a gain tester can vary from one instrument to another and can also vary on the same gain tester from one day to another, the gain results have been labeled to indicate which gain tester was used and what day the measurements were taken.

The data in TABLE I indicates that much of the gain from the whole film appears to be attributable to the wheel side layer, E-1 (21). Indeed, subsequent experiments have shown that the co-PET core layer does not have a significant effect on the optical results. It is also apparent that the gain is affected by which surface is towards the backlight. For these samples, the gain is higher when the wheel or air sides are positioned towards the light meter.

### Examples 8-38

These examples illustrate the lamination of individual polarizing sheets so as to form a multilayer polarizer.

Various combinations of the sheets formed in EXAMPLES 2-7 were laminated together to form composites. A small quantity of mineral oil was placed between the sheets to eliminate reflections from interior layer/air interfaces. A roller was used to gently remove any bubbles from the mineral oil in the composites. The mineral oil was spread over a circle at least 125 mm in diameter between the sheets. The Gain Test was then performed on these samples, the results of which are set forth in TABLE 2. The samples are identified following the protocol described in the previous examples. The layers making up the composite are listed in order, with the surface towards the backlight listed first.

TABLE 2
E-1 Composites Gain

| EXAMPLE | Sample | Gain² |
|---|---|---|
| 8 | E-1(41) | 1.432 |
| 9 | E-1(14) | 1.414 |
| 10 | E-1(14, 41) | 1.496 |
| 11 | E-1(12) | 1.302 |
| 12 | E-1(21) | 1.358 |
| 13 | E-1(34) | 1.296 |
| 14 | E-1(43) | 1.265 |
| 15 | E-1(12, 12) | 1.403 |
| 16 | E-1(21, 21) | 1.457 |
| 17 | E-1(12, 21) | 1.460 |
| 18 | E-1(21, 12) | 1.380 |
| 19 | E-1(34, 43) | 1.316 |
| 20 | E-1(43, 34) | 1.364 |
| 21 | E-1(43, 43) | 1.323 |
| 22 | E-1(34, 34) | 1.375 |
| 23 | E-1(12, 34) | 1.406 |
| 24 | E-1(43, 21) | 1.438 |
| 25 | E-1(21, 34) | 1.391 |
| 26 | E-1(43, 12) | 1.358 |
| 27 | E-1(12, 43) | 1.360 |
| 28 | E-1(34, 21) | 1.426 |
| 29 | E-1(21, 43) | 1.330 |
| 30 | E-1(34, 12) | 1.346 |
| 31 | E-1(12, 12, 21) | 1.508 |
| 32 | E-1(12, 21, 21) | 1.515 |
| 33 | E-1(12, 12, 12, 21) | 1.545 |
| 34 | E-1(12, 21, 21, 21) | 1.559 |
| 35 | E-1(12, 12, 12, 12, 21) | 1.558 |
| 36 | E-1(12, 21, 21, 21, 21) | 1.558 |
| 37 | E-1(12, 12, 12, 12, 12, 21) | 1.574 |
| 38 | E-1(12, 21, 21, 21, 21, 21) | 1.586 |

²Measured on gain tester #2, day 1

For the single layer samples, the results are similar to those from TABLE 1 in that the gain from the wheel side layer is greater than that from the air side layer, and the gain is higher when the wheel or air sides are positioned towards the light meter. It is noteworthy that the gain from E-1 (14) is approximately equal to the gain from E-1 (12,34) and the gain from E-1 (41) is approximately equal to the gain from E-1 (43,21), indicating that the delamination and mineral oil relamination processes do not appreciably affect the results.

It is apparent from TABLE 2 that very high gain values, even in excess of 1.58, can be achieved by proper assembly of blend polarizer films, and that these gain values far exceed those of the E-1 blend polarizer film itself. Thus, as illustrated in TABLES 2A and 2B, films with improved gain can be made by constructing multilayer films from the outer layers of films such as E-1. Moreover, the gain of the assembled films was observed to increase, over the range examined, with each additional layer. No attempt has been made here to determine the number of layers in these films that would optimize gain, though one skilled in the art will appreciate that this number could be readily determined for any particular film specimen. In the construction of multilayer composite films, tie layers, primers, and/or adhesive layers can be used to bond the individual blend layers (containing the continuous and disperse phase materials) when they are stacked together to form the multilayer composite.

TABLE 2A

| | Number of | | |
|---|---|---|---|
| Sample | Layers | Gain | Example # |
| E-1(21) | 1 | 1.358 | 12 |
| E-1(12, 21) | 2 | 1.460 | 17 |
| E-1(12, 12, 21) | 3 | 1.508 | 31 |
| E-1(12, 12, 12, 21) | 4 | 1.545 | 33 |
| E-1(12, 12, 12, 12, 21) | 5 | 1.558 | 35 |
| E-1(12, 12, 12, 12, 12, 21) | 6 | 1.574 | 37 |

TABLE 2B

| | Number of | | |
|---|---|---|---|
| Sample | Layers | Gain | Example # |
| E-1(12) | 1 | 1.302 | 11 |
| E-1(12, 21) | 2 | 1.460 | 17 |
| E-1(12, 21, 21) | 3 | 1.515 | 32 |
| E-1(12, 21, 21, 21) | 4 | 1.559 | 34 |
| E-1(12, 21, 21, 21, 21) | 5 | 1.558 | 36 |
| E-1(12, 21, 21, 21, 21, 21) | 6 | 1.586 | 38 |

Other observations from TABLES 2, 2A and 2B indicate that, for comparable samples:
the gain is higher in samples having the wheel (1) or air (4) surfaces on the exterior of the composite compared to samples in which the core (2 or 3) surfaces are on the exterior.
when a wheel or air surface is on the exterior of the composite, the gain is higher when that surface is positioned facing the light meter.
the gain is higher for composite films based on wheel side layers compared to composite films based on air side layers.

Additional testing was done on various films manufactured following the same general coextrusion/casting procedure as that used to make E-1, the various additional films being described generally as follows: some films had 3 co-extruded layers, others had only 1 co-extruded layer; the films had sPS as the disperse phase, and the sPS loading ranged from 30 wt % to 45 wt %; some films were stretched uniaxially, others were stretched biaxially; the films were made from various dies having die widths of 13.25, 14, and 18 inches; the films had a blend layer thickness, measured after stretching, ranging from about 2.5 mils (63 microns) to about 5 mils (127 microns). The results of these additional tests suggested the following.

(1) For a single layer film derived by delaminating an outer continuous/disperse phase layer from a 3-layer film of the type described in EXAMPLE 1, the gain increases when:
the caliper is increased while maintaining a constant wt % of the disperse phase;
the wt % sPS is increased while maintaining a constant caliper;
the Transverse Direction (TD) stretch ratio is increased;
the film is uniaxially (as opposed to biaxially) stretched.

(2) For a single layer film derived by delaminating an outer continuous/disperse phase layer from a 3-layer film of the type described in EXAMPLE 1, the normalized total intensity increases when:
the caliper was increased while maintaining a constant wt % of the disperse phase;
the wt % sPS is decreased while maintaining a constant caliper;
the TD stretch ratio is increased;
the film is uniaxially (as opposed to biaxially) stretched.

(3) For film composites, the maximum gain as a function of the number of layers increases when:
the caliper is decreased while maintaining a constant wt % of the disperse phase;
the wt % sPS is increased while maintaining a constant caliper;
the film is biaxially (as opposed to uniaxially) stretched.

(4) For film composites, the normalized total intensity as a function of the number of layers increases when:
the caliper is decreased while maintaining a constant wt % of the disperse phase;
the wt % sPS is decreased while maintaining a constant caliper;
the TD stretch ratio is increased;
the film is uniaxially (as opposed to biaxially) stretched (lesser effect).

It has been shown that high gain composite films can be achieved by de-lamination and re-lamination of wheel side layers from multilayer blend polarizers (see TABLE 2). Comparable gain can also be achieved by laminating the thinnest single layer blend polarizer films. It can be seen from these results that one can modify gain and/or total intensity via de-lamination and re-lamination of extruded thin blend layers into composite films. Based upon the desired optical characteristics of the composite film, it can also be seen that the performance can be controlled by the number of layers as well as the process parameters for making the original blend polarizers. For instance, if a high normal angle gain is desired, one can choose individual blend layers with a high wt % disperse phase that has either a thick caliper (but not too thick) or is a composite of thin caliper (e.g., less than about 130 microns) films. If a wide viewing angle is desired, one can design the 0° and 40° gains to be high and approximately equal. For such a film, one can choose a composite of thin films each containing a lower wt % disperse phase. Other optical targets can be achieved in a similar manner.

An additional observation can be made with regard to the extrusion of thin single layer films and subsequent stacking of those films into a multilayer composite. For a given caliper of the multilayer composite, a higher gain is often achieved if a greater number of relatively thin layers are used rather than a smaller number of thicker layers.

The preceding description of the present invention is merely illustrative, and is not intended to be limiting. Therefore, the scope of the present invention should be construed solely by reference to the appended claims.

What is claimed is:

1. A method for making an optical film, comprising:
providing a melt stream having a continuous phase comprising a first polymeric material and a disperse phase comprising a second polymeric material;
passing the melt stream through a plurality of vanes; and
extruding the melt stream through a die.

2. The method of claim 1, further comprising:
casting the extruded melt stream against a casting surface to form a cast film.

3. The method of claim 2, further comprising:
orienting the cast film by stretching along at least one direction.

4. The method of claim 1, wherein the melt stream has a principle direction of flow along a first axis, and wherein each of the plurality of vanes has a longitudinal axis that is disposed essentially perpendicular to the first axis.

5. The method of claim 1, wherein the plurality of vanes is disposed in the die.

6. The method of claim 1, wherein the die comprises die lips, and wherein the plurality of vanes is disposed adjacent to the die lips.

7. The method of claim 6, wherein the plurality of vanes is spaced apart from the die lips.

8. The method of claim 1, wherein the plurality of vanes defines a plurality of narrow channels, and wherein the melt stream passes through the plurality of narrow channels.

9. The method of claim 8, wherein the melt stream recombines into a singular melt stream after passing through the plurality of narrow channels.

10. The method of claim 1, wherein each of the plurality of vanes is disposed orthogonal to a direction of flow of the melt stream.

11. The method of claim 1, wherein the die is selected from the group of a manifold extrusion die, a drop die, and a casting die.
